(19) United States
(12) Patent Application Publication
(10) Pub. No.: US 2025/0196352 A1
(43) Pub. Date: Jun. 19, 2025

(54) Planning a Path of a Robot

(71) Applicants: KUKA Deutschland GmbH, Augsburg (DE); KUKA Systems GmbH, Augsburg (DE)

(72) Inventors: Ingo Kresse, Augsburg (DE); Juergen Blume, Friedberg (DE); Pascal Caprano, Augsburg (DE); Marcus Hofmann, Seesen (DE); Fabian Jennrich, Muenchen (DE)

(73) Assignees: KUKA Deutschland GmbH, Augsburg (DE); KUKA Systems GmbH, Augsburg (DE)

(21) Appl. No.: 18/846,903

(22) PCT Filed: Mar. 13, 2023
(86) PCT No.: PCT/EP2023/056357

§ 371 Date: Sep. 13, 2024

(30) Foreign Application Priority Data
Mar. 15, 2022 (DE) 10 2022 202 562.8
Mar. 15, 2022 (DE) 10 2022 202 563.6
Mar. 15, 2022 (DE) 10 2022 202 564.4
Mar. 15, 2022 (DE) 10 2022 202 569.5
Mar. 15, 2022 (DE) 10 2022 202 571.7

(51) Int. Cl. B25J 9/16; B25J 13/06; B25J 13/08

(52) U.S. Cl. CPC B25J 9/1666; B25J 9/1671; B25J 13/06; B25J 13/08

(57) ABSTRACT

A method for planning a path includes data of real surroundings of the robot using a detection device, in particular a mobile detection device, in particular a portable detection device; ascertaining a computer-implemented three-dimensional surroundings model on the basis of the detected data, in particular using at least one approximation of features, in particular points, detected using the detection device; planning a first path of the robot on the basis of the surroundings model and a computer-implemented model of the robot such that a collision between the robot model and the surroundings model is prevented; and visualizing a virtual representation of the planned first path using a visualization device in an augmented reality.

### CROSS-REFERENCE TO RELATED APPLICATIONS

This application is a national phase application under 35 U.S.C. § 371 of International Patent Application No. PCT/EP2023/056357, filed Mar. 13, 2023 (pending), which claims the benefit of priority to German Patent Application Nos. DE 10 2022 202 562.8, DE 10 2022 202 563.6, DE 10 2022 202 564.4, DE 10 2022 202 569.5, and DE 10 2022 202 571.7, each filed Mar. 15, 2022; and is related to U.S. patent application Ser. No. ______ (Attorney Docket No. KUKAR-188), U.S. patent application Ser. No. ______ (Attorney Docket No. KUKAR-190), U.S. patent application Ser. No. ______ (Attorney Docket No. KUKAR-192), and U.S. patent application Ser. No. ______ (Attorney Docket No. KUKAR-193), each filed Sep. 13, 2024, the disclosures of which are incorporated by reference herein in their entirety.

### TECHNICAL FIELD

The present invention relates to a method and system for planning a path of a robot and to a computer program or computer program product for carrying out the method.

### BACKGROUND

In simulation environments, robot paths on which a robot also avoids collisions with obstacles that are modeled as computer-implemented in the simulation environment can be advantageously planned in advance, in particular by means of optimizers.

In a real environment, this has so far been done manually according to internal company practice, which is not only time-consuming, but also requires considerable experience on the part of the commissioner. On the other hand, the paths planned in advance in a simulation environment cannot be easily executed in real environments if, for example, real obstacles have not been modeled or have been modeled incorrectly or have been removed after the simulation environment has been created.

### SUMMARY

The object of the present invention is to improve the operation of robots, in particular (by) planning their paths.

This object is achieved by a method, a system, or a computer program or computer program product for carrying out a method as described herein.

According to one embodiment of the present disclosure, a method for planning a path of a robot (“robot path”) comprises the steps of:
detecting data of a real environment of the robot by means of a detection device which is mobile in one embodiment and portable in a further embodiment, in particular by a person;
determining a computer-implemented three-dimensional model of the environment on the basis of this captured data, in one embodiment using at least one approximation of features, in particular points, captured using the detection device;
planning a first path of the robot based on this environment model and a computer-implemented model of the robot such that a collision between this robot model and the environment model is avoided; and
visualizing a virtual representation of this planned first path using a visualization device in an augmented reality.

By creating an environment model of the real environment with the help of the detection device or data captured by it and using it for planning, a collision-free path can be advantageously planned theoretically in advance in one embodiment using algorithms known per se for simulation environments or software-based path planning tools, particularly advantageously with the aid of algorithms or software optimization tools known per se for simulation environments in such a manner that the robot not only avoids collisions with the environment on the path, but at the same time is also optimal with regard to a specified quality criterion as far as possible, for example within the framework of a specified accuracy, number of iterations, computing time, variation possibility or similar. Accordingly, the first path in an embodiment is planned using an optimization of a specified one- or multi-dimensional quality criterion. In one embodiment, the absence of collisions can be taken into account as a boundary condition and in another embodiment as part of the quality criterion, in particular in the form of a penalty function, for example by not allowing paths with collisions during optimization or by collisions deteriorating the value of the quality criterion so powerfully that the corresponding path is not optimal and is discarded accordingly. The visualization allows a planner to check the planned path in the augmented reality and, in particular, to identify problems that may result, for example, from a change (in) the environment that occurred after the environment was recorded and was not taken into account during planning, inaccurate modeling of the robot or incorrect path planning.

In one embodiment, the quality criterion depends on a time required for traversing the path with the robot and/or on an energy required for traversing the path with the robot and/or on a distance of the robot from the environment; in a further embodiment, it depends on a minimum distance of the robot from the environment when traversing the path with the robot. In particular, the (first) path can be planned in such a manner that the time required for traversing this path with the robot is minimal, the energy required for traversing this path with the robot (for this) is minimal, the minimum or mean distance of the robot from the environment when the robot is traversing this path is maximum or similar, wherein in particular a mixed, preferably weighted, quality criterion can be used which jointly takes into account two or more of the above-mentioned aspects and/or further aspects, for example velocities, accelerations and/or jerks of the robot or similar.

This makes it possible to plan paths that are particularly advantageous for robots.

In addition or as an alternative to the optimization explained above, in one embodiment the method may comprise the steps of:
planning one or more further paths of the robot (respectively) based on the environment model and the model of the robot in such a manner that a collision between the robot model and the environment model is avoided;
visualizing a virtual representation of said planned further path(s) using the visualization device in the augmented reality together with the virtual representation of the first path; and
selecting a path from a set comprising the first and the further path(s) on the basis of a user input.

The user input takes place in one version using the visualization device.

By planning and visualizing two or more (already theoretically) collision-free paths, a planner can be provided with advantageous possible alternatives in one version, from which he then selects a particularly advantageous one by means of user input after checking the alternatives with the help of or in the augmented reality. The selected path and/or the path planned with the help of an optimization can then be traversed with the real robot in a further method step or the method can comprise this step. This allows a planner to plan a collision-free path that is advantageous from his point of view particularly easily, quickly and/or reliably, wherein he can in particular reject paths that are theoretically collision-free, but where he discovers a collision or other weakness on the basis of the visualization in the augmented reality.

In one embodiment, the first path and/or the one or more of the further path(s) are each planned on the basis of one or more specified path points, in a further embodiment on the basis of a specified initial path. In one embodiment, the respective path is planned in such a manner that it runs through the specified path point(s). In further embodiment, the specified initial path is used as the start for path planning, in particular optimization.

By using specified path points, the planned path can be adapted to the real environment in a particularly advantageous manner, by using a specified initial path, the path planning, in particular optimization, can converge in a particularly advantageous manner and/or the user can be provided with particularly advantageous alternatives to choose from. In one embodiment, the user can initially specify an initial path, wherein the first path and/or the further path(s) are planned on the basis of this initial path, in a further embodiment by automatic modification. In this manner, an (initial) path specified by the user can be (re)planned or modified into a collision-free path that is preferably optimal or optimized with regard to a specified quality criterion.

In one embodiment, (one or more) of the specified path point(s), in one embodiment of the further development the specified initial path, is/are predetermined by, in one embodiment hand-guided, approaching or traversing with a real robot, preferably with the robot for which the path is planned. In one embodiment, a manually guided approaching or traversing comprises manually moving the robot by applying forces to it.

This allows the planned path to be adapted to the real environment or the robot in a particularly advantageous manner.

Additionally or alternatively, in one embodiment (one or more) of the specified path point(s), in an embodiment of the further development the specified initial path, is/are specified in advance, with the aid of a simulation environment and/or by offline programming.

As a result, path planning, in particular optimization, can converge particularly advantageously in one embodiment and/or particularly advantageous alternatives can be made available to the user for selection.

In one embodiment, the robot comprises a robot arm with three or more, preferably at least six, in one embodiment at least seven, joints, in a further embodiment swivel joints, which connect movable links of the robot to one another and are movable by drives, in particular motors, of the robot, and/or a mobile base, in particular one which can be moved with the aid of at least one drive, in particular motor, of the robot. The invention is particularly advantageous for such robots, particularly due to the complex paths it enables. In one embodiment, a robot-guided tool or workpiece forms a (distal) movable link of the robot within the meaning of the present invention, or the model of the robot (also) comprises a model of a robot-guided tool or workpiece.

In one embodiment, the three-dimensional environment model comprises data, in particular permanently or temporarily stored data, which recite or describe one or more three-dimensional contour(s) or geometry (geometries) of a real environment of the robot, in particular a robot cell, production or storage hall or similar.

In one embodiment, the model of the robot comprises data, in particular permanently or temporarily stored data, which recite or describe the three-dimensional contour(s) or geometry (geometries) of the (real) robot, in particular of one or more of its movable links. As mentioned above, in one embodiment, a robot-guided tool or workpiece forms a (distal) movable link of the robot within the meaning of the present invention, or the model of the robot (also) comprises a model of a robot-guided tool or workpiece.

In one embodiment, the detection device is arranged on the visualization device, in a further embodiment integrated thereon or detachable therefrom. As a result, in one embodiment the environment model can be advantageously determined in situ or promptly before planning or visualization and thus be particularly up-to-date and thus the path can be planned particularly advantageously.

In one embodiment, the detection device is moved translationally and/or rotationally and/or manually, in particular by a planner handling the visualization device, to detect the data relative to the real environment. In one embodiment, a larger area of the environment and/or the environment can be detected (more) precisely and thus the path planned in a particularly advantageous manner.

In one embodiment, the detection device comprises one or more non-contact measuring distance meters, in a further embodiment one or more radar distance meters, one or more ultrasonic distance meters and/or one or more lidar distance meters. This allows the environment model to be determined precisely in one embodiment and the path to be planned in a particularly advantageous manner. Lidar distance meters are particularly advantageous here, as they are compact and measure precisely.

Additionally or alternatively, the detection device comprises one or more cameras, in one embodiment a 3D camera system, which in one embodiment comprises at least two or stereo cameras, a triangulation system, in which at least one light source images a defined pattern onto the environment and at least one camera captures this pattern, preferably from a different angle of view, at least one TOF camera, at least one interferometry camera, at least one light field camera or similar, and/or image evaluation. In one embodiment, the environment can be detected (more) quickly and thus the method carried out particularly quickly and/or a larger environment taken into account.

In one embodiment, in addition to being determined on the basis of the detected data of the real environment, the environment model is determined (also) on the basis of specified nominal data, in a further development CAD data, of the environment. By taking such data into account, the environment model can be determined (more) quickly and/or (more) precisely.

In one embodiment, the model of the robot is determined on the basis of specified nominal data, in a further development CAD data, of the robot and/or a measurement of the robot. By taking such data into account, the model of the robot can be determined (more) quickly and/or (more) precisely. In one embodiment, the model of the robot comprises or recites a pose of the robot links relative to one another and/or a reference system fixed to the environment, determined by this planned path, for different portions, in particular points, of the planned path. In one embodiment, a pose or position and orientation within the meaning of the present invention comprises a one-, two- or three-dimensional position and/or a one-, two- or three-dimensional orientation.

As explained above, in one embodiment, a robot-guided tool or workpiece forms a movable link of the robot within the meaning of the present invention. Accordingly, in one embodiment, the model of the robot comprises a computer-implemented model of a robot-guided tool or workpiece as a movable link of the robot. In one embodiment, this can advantageously reduce the risk of a robot-guided tool or workpiece colliding with the environment. Accordingly, in one embodiment, the model of the robot is determined on the basis of specified nominal data, in a further embodiment CAD data, of the tool or workpiece, and/or a measurement of the tool or workpiece.

In one embodiment, the environment model comprises one or more geometry primitives in a specified relation, in particular spatial position and orientation, to a real environment obstacle, in particular thus to several real environment obstacles, in each case at least one geometry primitive in a specified relation, in particular spatial position and orientation, to this real environment obstacle. Additionally or alternatively, in one embodiment, the model of the robot comprises one or more geometry primitives in a specified relation, in particular spatial position and orientation, to a link of the robot, in particular thus to several links of the robot, preferably at least one end effector, in each case at least one geometry primitive in a specified relation, in particular spatial position and orientation, to this robot link. A collision-free path can thereby be planned (more) quickly in one embodiment. In one embodiment, a geometry primitive within the meaning of the present invention is a polyhedron, in particular a prism, in particular a cuboid, or a cylinder, cone, ellipsoid, in particular a sphere, or similar. This means that a collision-free path can be planned particularly quickly in one embodiment.

In one embodiment, the environment model is determined with the aid of at least one approximation of features, in particular points, detected with the aid of the detection device, particularly preferably a point cloud detected with the aid of the detection device, in a further embodiment with the aid of one or more grids and/or one or more approximation surfaces, in particular planar approximation surfaces and/or single or multiple curved approximation surfaces, wherein such grids or approximation surfaces are determined in one embodiment by equalization, in particular interpolation or extrapolation, smoothing and/or other fitting functions of features detected by the detection device, in particular points, in particular the environment model may comprise this approximation. In one embodiment, such an approximation can be used to model the environment respectively in a particularly advantageous manner, in particular quickly and/or precisely.

In one embodiment, the environment model is determined on the basis of the robot, in particular with the aid of one of the, in particular the, items of data detected by the robot, in particular the detection device, and/or on the basis of the model of the robot. In a further embodiment, the robot, which may also be detected during the detection of data from the robot's real environment using the detection device, is at least partially eliminated or masked out. This allows the environment model to be improved in one embodiment.

In one embodiment, the environment model is determined based on a selection of an environment area by a planner. In a further embodiment, an environment area selected by the planner is not taken into account by the environment model, in a further embodiment it is not detected by the detection device, and/or only an environment area selected by the planner is taken into account by the environment model, in a further embodiment only this environment area is detected by the detection device. The environment model can thereby be improved and/or determined (more) quickly in one embodiment.

In one embodiment, the visualization device is a mobile, in particular portable (by a person, preferably with one hand), visualization device, in one embodiment comprising a handheld apparatus, preferably a handheld, tablet, smartphone, laptop or similar, and/or glasses, in particular A(ugmented) R(eality) glasses. As a result, the detection, planning and/or visualization can be carried out in situ or on site and thus improved. In one embodiment, the visualization device is set up (in terms of hardware and/or software) to control the robot or is (also) used for this purpose. This means that commissioning can be carried out (more) quickly and/or (more) safely in one embodiment.

In one embodiment, the (visualized) virtual representation of the planned first path and/or (of one or more of) the further path(s) each comprises a, in one embodiment continuous, path of a robot-fixed reference point, preferably an end effector of the robot, and/or a depiction of one or more, in particular all, movable links of the robot, in one embodiment by means of or by geometry primitives of the model of the robot. In one embodiment, the representation of the link or links of the robot changes during the visualization according to the (respectively) planned or visualized path; accordingly, the virtual representation may comprise, in particular, a virtual simulation of the robot or representation of the movement of one or more of its links when traversing this path.

By visualizing the path, the planned path can be checked (more) quickly and/or (more) reliably, in particular a test person can check or assess the path (more) easily, (more) intuitively and/or (more) quickly.

In one embodiment, when visualizing the virtual representation of the first path and/or (one or more) of the further path(s), one or more parameters of this path are issued to the planner, in one embodiment a velocity and/or at least one parameter, for example a velocity, for at least one portion, in particular point, of this path selected, in particular by the planner, and/or at least one parameter, for example a velocity, for a portion, in particular point, of this path that is currently or actually being simulated during visualization.

A parameter is output numerically, acoustically and/or symbolically in one embodiment. For example, a direction of travel can be output by an arrow, a TCP velocity by a corresponding number or by a tone, in particular in relation to a reference tone, which can in particular be assigned to a zero value or reference value of the parameter.

This allows a planner to check or assess the path (more) quickly and/or (more) reliably.

A system or method in accordance with the disclosure can be used with particular advantage during or for commissioning the robot and/or for transfer paths in which the robot is to move from an initial pose to a target pose without colliding with the environment, since safety can be increased and/or effort and/or time can be reduced with particular advantage during commissioning and transfer paths, but it is not limited to this.

According to one embodiment of the present disclosure, a system, in particular in terms of hardware and/or software, in particular in terms of programming, is configured to perform a method described herein and/or comprises:
a, in particular mobile, in particular portable, detection device for detecting data of a real environment of the robot;
means for determining a computer-implemented three-dimensional model of the environment on the basis of this detected data, in particular by means of at least one approximation of features, in particular points, detected by means of the detection device;
means for planning a first path of the robot based on this environment model and a computer-implemented model of the robot such that a collision between this robot model and the environment model is avoided; and
a visualization device for visualizing a virtual representation of this planned first path in an augmented reality.

In an embodiment, the system or its means comprises:
an optimizer for planning the (first) path with the aid of an optimization of a specified quality criterion, wherein the quality criterion depends preferably on a time and/or energy required for traversing the path with the robot and/or a distance of the robot from the environment; and/or
means for planning one or more further paths of the robot based on the environment model and the model of the robot in such a manner that a collision between the robot model and the environment model is avoided, wherein the visualization device visualizes a virtual representation of these planned further path(s) in the augmented reality together with the virtual representation of the first path, and means for selecting a path from a set comprising the first and the further path(s) based on a user input; and/or
means for planning the first path and/or the further path(s) on the basis of at least one specified path point, in particular a specified initial path, in particular means for specifying the at least one path point, in particular the specified initial path, in advance by means of, in particular hand-guided, approach or traversing with a, in particular the, real robot, by means of a simulation environment and/or by means of offline programming; and/or
means for determining the model of the robot on the basis of specified nominal data, in particular CAD data, of the robot and/or a measurement of the robot; and/or
means for determining the environment model on the basis of the robot, in particular with the aid of one of the, in particular the, items of data detected by the robot, in particular the detection device, and/or on the basis of the model of the robot and/or on the basis of a selection of an environment area by a planner; and/or
means for outputting at least one parameter of the first path and/or of the at least one further path when visualizing the virtual representation of this path, in particular a velocity and/or for at least one selected portion, in particular point, of this path and/or for a portion, in particular point, of this path simulated during visualization, in particular numerically and/or symbolically.

A system and/or a means in the sense of the present disclosure may be designed in hardware and/or in software, and in particular may comprise at least one, in particular digital, processing unit, in particular microprocessor unit (CPU), graphic card (GPU) or the like, which is preferably data-connected or signal-connected to a memory system and/or bus system, and/or one or multiple programs or program modules. The processing unit may be designed to process commands that are implemented as a program stored in a memory system, to detect input signals from a data bus and/or to output output signals to a data bus. A memory system may comprise one or more, in particular different, storage media, in particular optical, magnetic, solid-state, and/or other non-volatile media. The program may be such that it embodies or is capable of executing the methods described herein, so that the processing unit can execute the steps of such methods and thus, in particular, plan the path(s) and/or control the robot during or for the traversing thereof. In an embodiment, a computer program product may comprise, in particular be, a, in particular computer-readable and/or non-volatile, storage medium for storing a program or instructions or with a program stored thereon or with instructions stored thereon. In an embodiment, execution of said program or said instructions by a system or controller, in particular a computer or an arrangement of a plurality of computers, causes the system or controller, in particular the computer(s), to carry out a method described herein or one or more steps thereof, or the program or instructions are configured to do so.

In an embodiment, one or more, in particular all, steps of the method are implemented completely or partially automatically, in particular by the system or its means.

In one embodiment, the system comprises the robot.

In one embodiment, the method has the step of:
modifying the first path and/or (one or more of) the further path(s) based on a user input, in a further embodiment the path selected from the first path and the further path(s).

This allows the planner to advantageously adapt the corresponding path in one embodiment to the real environment and/or changed boundary conditions and/or additional requirements.

Additionally or alternatively, in one embodiment, the method comprises the step of:
traversing the planned, possibly selected and/or modified, path with the robot.

This allows the planner to check the corresponding path in a design advantageously with the real robot.

In one embodiment, the quality criterion used in the optimization is specified on the basis of a user input. For example, the user or planner can select one or more (sub)criteria and/or their weighting or the like from a specified set.

Accordingly, in one embodiment, the system or its means comprises:
means for modifying the first and/or at least one further, in particular the selected, path on the basis of a user input; and/or
means for traversing the, possibly selected and/or modified, path with the robot; and/or
means for specifying the quality criterion based on a user input.

In one embodiment, the method also comprises operating the robot by traversing the, possibly selected and/or modified, path with the robot, and can thus in particular be a method for operating a or the robot. Accordingly, in one embodiment, the system can also be a system for operating a robot or the robot.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 schematically depicts a system for planning a path of a robot according to an embodiment of the present disclosure; and

FIG. 2 illustrates a method of planning the path according to one embodiment of the present disclosure.

### DETAILED DESCRIPTION

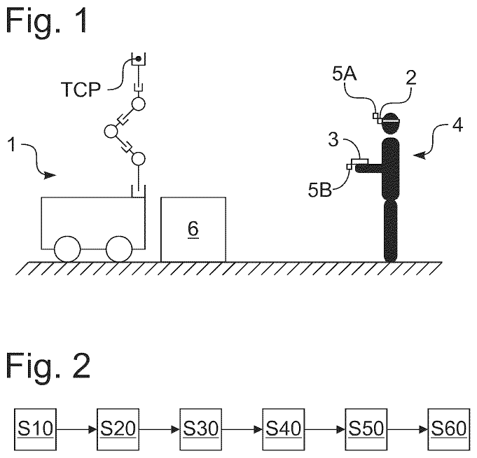

FIG. 1 shows a system for testing, by a planner 4, of a specified path of a robot 1 using a visualization device in the form of AR glasses 2 or a tablet 3.

In a step S10 (see FIG. 2), a real environment 6 of the robot is detected with the aid of a detection device 5A or 5B, preferably integrated thereon or detachable therefrom, arranged on the visualization device 2 or 3, for example a 3D camera system, lidar sensor or similar, and a computer-implemented environment model is determined in a step S20 with the aid of this data. In a modification not shown, the environment model can also be created on the basis of nominal data from the environment.

In a step S30, a first path of the robot is planned on the basis of this environment model and a computer-implemented model of the robot in such a manner that a collision between this robot model and the environment model is avoided.

In one embodiment, the first path is planned using an optimization of a specified quality criterion, for example a mixed quality criterion in the form of a weighted sum of at least two of: the time required to traverse the path, the energy required to traverse the path, the minimum distance between the robot, possibly with a robot-guided tool or piece, and the environment when traversing the path, the maximum velocity occurring when traversing the path, the maximum acceleration occurring when traversing the path, the maximum jerk occurring when traversing the path and/or other subcriteria. Here, freedom from collision can be advantageously considered as a boundary condition or additional sub-criteria in the optimization. This is, of course, purely exemplary, without the invention being limited to such optimization. In one embodiment, the planner specifies the quality criterion with the help of a user input.

In one embodiment, in step S30, in addition to the first path, one or more further alternative collision-free paths of the robot are planned.

In a step S40, a virtual representation of the first path and possibly the further path(s) is visualized in augmented reality using the visualization device 2 or 3, for example the path of the TCP as a line and/or the geometry primitives during simulated traversal of the (respective) path, wherein the paths are traversed in parallel in one embodiment and simulated one after the other in another embodiment.

With the help of this visualized virtual representation(s), the planner 4 can check in step S40 whether the planned path meets (his) requirements, for example whether it is collision-free in the augmented reality.

If necessary, in a step S50, it selects a path from a set comprising the first and the further path(s) by means of user input and/or modifies the first or selected path by means of user input.

The tested, possibly selected or modified, path can then be traveled with the real robot in step S60.

Although exemplary embodiments have been explained in the preceding description, it is pointed out that a large number of modifications is possible. It is also pointed out that the exemplary embodiments are merely examples that are not intended to restrict the scope of protection, the applications, and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such de-tail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 Robot
2 AR glasses
3 tablet
4 planner
5A; 5B detection device
6 environment
TCP tool center point

What is claimed is:

1. A method for planning a path of a robot (1), comprising the steps of:
detecting (S10) data of a real environment (6) of the robot by means of a, in particular mobile, in particular portable, detection device (5A; 5B);
determining (S20) a computer-implemented three-dimensional model of the environment on the basis of this detected data, in particular by means of at least one approximation of features, in particular points, detected by means of the detection device;
planning (S30) a first path of the robot based on this environment model and a computer-implemented model of the robot such that a collision between this robot model and the environment model is avoided; and
visualizing (S40) a virtual representation of this planned first path using a visualization device in an augmented reality.

2-14. (canceled)
